(19) United States
(12) Patent Application Publication
(10) Pub. No.: US 2019/0040960 A1
(43) Pub. Date: Feb. 7, 2019

(54) METAL SEAT BALL VALVE APPARATUS PROVIDED WITH MICRO-ALLOYING LAYER, AND METHOD FOR MANUFACTURING SAME

(71) Applicant: KST PLANT COMPANY, Busan (KR)

(72) Inventors: Sung Tae KIM, Gimhae (KR); Sang Kwon KIM, Gwangmyeong (KR); Il Gun KIM, Busan (KR)

(21) Appl. No.: 15/715,856

(22) Filed: Sep. 26, 2017

(30) Foreign Application Priority Data
Aug. 7, 2017 (KR) 10-2017-0099456

(51) Int. Cl. F16K 1/14; F16K 5/06; F16K 27/06

(52) U.S. Cl. CPC F16K 1/14; F16K 27/067; F16K 5/0689

(57) ABSTRACT

Disclosed are a metal seat ball valve apparatus provided with a micro-alloying layer and a method for manufacturing the same. The metal seat ball valve apparatus ensures that a ball valve performs a precise trouble-free smooth operation in diverse environments, such as ultralow temperature, high temperature, and high pressure.

### CROSS REFERENCE TO RELATED APPLICATION

The present application claims priority to Korean Patent Application No. 10-2017-0099456, filed Aug. 7, 2017, the entire contents of which is incorporated herein for all purposes by this reference.

### BACKGROUND OF THE INVENTION

### Field of the Invention

The present invention generally relates to a metal seat ball valve apparatus with a micro-alloying layer formed thereon and a method for manufacturing same, the apparatus ensuring a precise trouble-free smooth operation of a ball valve under in diverse environments, for example, at cryogenic temperatures or at high pressures and temperatures.

### Description of the Related Art

Generally, a ball valve refers to a device installed in a power or fluid transport pipe to open and close an opening and closing hole through which a fluid flow passes. Typically, a ball valve includes a ball unit rotating in one direction in a valve body, a handle unit (called a stem) to rotate the ball unit, and a seat unit surrounding and being in tight contact with the external surface of the ball unit to prevent a gap from being formed between the valve body and the ball unit. The ball unit has a through hole formed to correspond to the opening and closing hole.

When designing a typical ball valve, it is required to ensure sealability to prevent leakage of fluid which is a material transported through a pipe, durability to prevent abrasion of seats attributable to friction between the ball valve and the seats, and precise control to regulate the flow rate of fluid, which changes in accordance with rotation of a ball. Even in extreme environments required for transport of cryogenic LNG gas, for example, specifically at a cryogenic temperature of −197° C. or below, constant sealability, durability, precise and accurate control, easy manipulation need to be maintained, regardless of expansion and contraction of a metal in such cryogenic environments.

Conventionally, ball units are made of a resin-based soft material such as Teflon. Such a ball unit made of a soft material is advantageous in terms of reduction of manufacturing costs of a ball valve apparatus, but also has shortcomings that it increases operation torque of a ball valve apparatus because it is put under high pressure during assembling and it shortens the lifespan of a ball valve apparatus due to poor durability of Teflon.

Furthermore, a large actuator is required due to the high operation torque of the ball valve apparatus, which increases the overall volume and weight of the ball valve apparatus.

For this reason, the inventor of the present application has been made an effort to solve the problems and overcome the limitations of convention ball valve apparatuses employing a ball unit made of a soft material and, as a result, provides a metal seat ball valve apparatus provided with a micro-alloying layer formed thereon and a method for manufacturing the same, the apparatus ensuring a precise trouble-free smooth operation of a ball valve in diverse environments, such as cryogenic temperature, high pressure and high temperature, etc., by manufacturing a metal ball and a metal seat provided with a micro-alloying layer as a surface layer, whereby the overall metal ball maintains a predetermined thermal expansion coefficient even at a temperature of −197° C. by having the same or similar material structure as a housing, and the ball unit can smoothly rotate at the low temperature because the micro-alloying layer having a high rigidity and low friction coefficient is formed on the surface thereof and because the ball unit has a high sphericity obtained through surface machining.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and an object of the present invention is to provide a metal seat ball valve apparatus provided with a micro-alloying layer and a method for manufacturing same, the apparatus ensuring a precise trouble-free smooth operation of a ball valve in diverse environments, for example, at cryogenic temperatures or at high temperatures and pressures, by coating a metal ball and a metal seat with a metal maintaining a predetermined thermal expansion coefficient even at a temperature of −197° C. and by performing surface machining on the metal ball to ensure a high sphericity of the metal ball.

In order to accomplish the above object, according to one aspect of the present invention, there is provided a metal seat ball valve apparatus provided with a micro-allying layer, the apparatus including: a valve body having a channel for a power flow or a fluid flow; a metal ball valve having an opening and closing hole passing through the metal ball valve, the metal ball valve selectively opening and closing the channel by rotating in one direction; metal seats respectively disposed at an input port and an output port of the channel and arranged to surround an external surface of the metal ball valve in a tight contact manner; and a stem rotating the metal ball valve in one direction, wherein the metal ball valve and the metal seats undergo a metal coating process and a surface machining process when manufactured.

According to one embodiment, the metal ball valve and the metal seats may be made of a material having a thermal expansion coefficient similar to that of the valve body. A micro-alloying layer corresponding to a K-chromium carbide layer may be formed on the surfaces of the metal ball valve and the metal seats and is then thermally treated to form a high concentration diffusion layer in conjunction with internal alloy elements. The surfaces of the metal ball valve and the metal seats may be provided with the micro-alloying layer providing a highly rigid and friction-free metal surface. The micro-alloying layer may be thin to have a micrometer-order thickness and not to influence the overall thermal expansion coefficient of the metal ball valve and the metal seats. The micro-alloying layer provides a surface enabling the metal ball valve to easily rotate.

According to one embodiment, a coefficient of friction between the metal ball valves and the metal seats may be 0.5 or less.

According to one embodiment, the metal ball valve may have a sphericity of 0.002 mm or less after undergoing the surface machining process.

According to one embodiment, the metal ball valve and the metal seats may maintain a predetermined rigidity at a temperature range of from −197° C. to 750° C.

According to one embodiment, the metal ball valve and the metal seats may have corrosion resistance.

According to one embodiment, the metal ball valve and the metal seats may have surface rigidity as hard as a Vickers hardness number of 1700 HV.

In order to accomplish the objective of the present invention, according to another aspect, there is provided a method for manufacturing a metal seat ball valve apparatus provided with a micro-alloying layer, the method including: forming a channel for a powder flow or a fluid flow in a valve body; manufacturing a metal ball valve selectively opening and closing the channel by rotating in one direction; forming an opening and closing hole that passes through the metal ball valve; manufacturing metal seats to be respectively disposed at an input port and an output port of the channel and to surround an external surface of the metal ball valve in a tight contact manner; manufacturing a stem rotating the metal ball valve in one direction; performing a metal coating process and a surface machining process on surfaces of the metal ball valve and the metal seats; and assembling the valve body, the metal ball valve, the metal seats, and the stem to produce the metal seat ball valve apparatus.

According to one embodiment, the performing of the metal coating process and the surface machining process may include a process of coating the surfaces of the metal ball valve and the metal seats with a micro-alloying layer such as a chrome alloy layer having a thermal expansion coefficient similar to that of the material of the metal ball valve and the metal seats through micro-alloying coating.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view illustrating the overall construction of a metal seat ball valve apparatus 100 provided with a micro-alloying layer, according to one embodiment of the present invention;

FIG. 2 is a picture of an actual metal seat ball valve apparatus 100 provided with a micro-alloying layer, shown in FIG. 1;

FIG. 3 is a schematic view illustrating the constructions of a metal ball valve 120 and a metal seat 130 shown in FIG. 1;

FIGS. 4A and 4B are a picture of an actual ball valve 120 and an actual metal seat 130 shown in FIG. 3; and

FIG. 5 is a flowchart sequentially describing a method of manufacturing the metal seat ball valve apparatus 100 provided with the micro-alloying layer, according to one embodiment of the present invention shown in FIG. 1.

### DETAILED DESCRIPTION OF THE INVENTION

Hereinbelow, exemplary embodiments of the present invention will be described in detail to aid in the understanding of the present invention. However, those exemplary embodiments should not be construed as limiting the scope of the present invention.

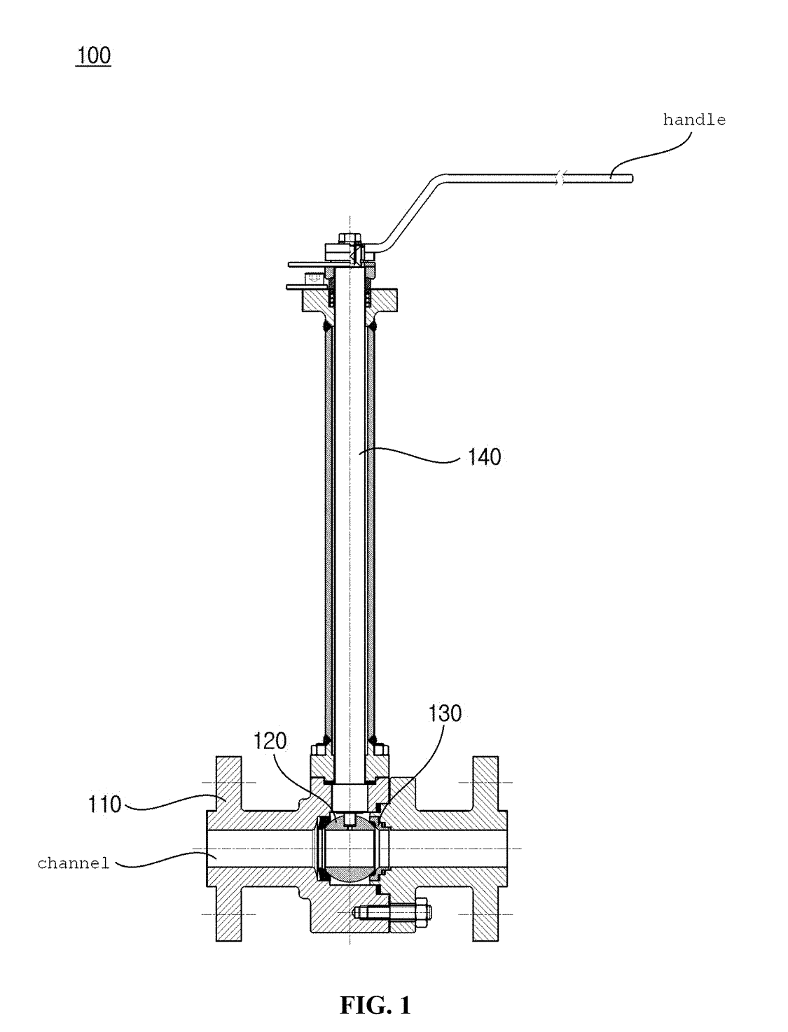

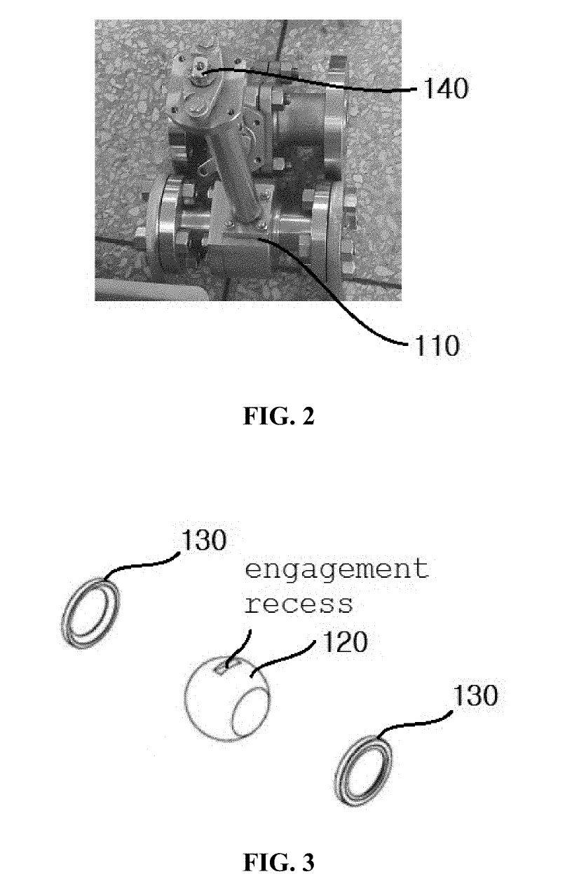

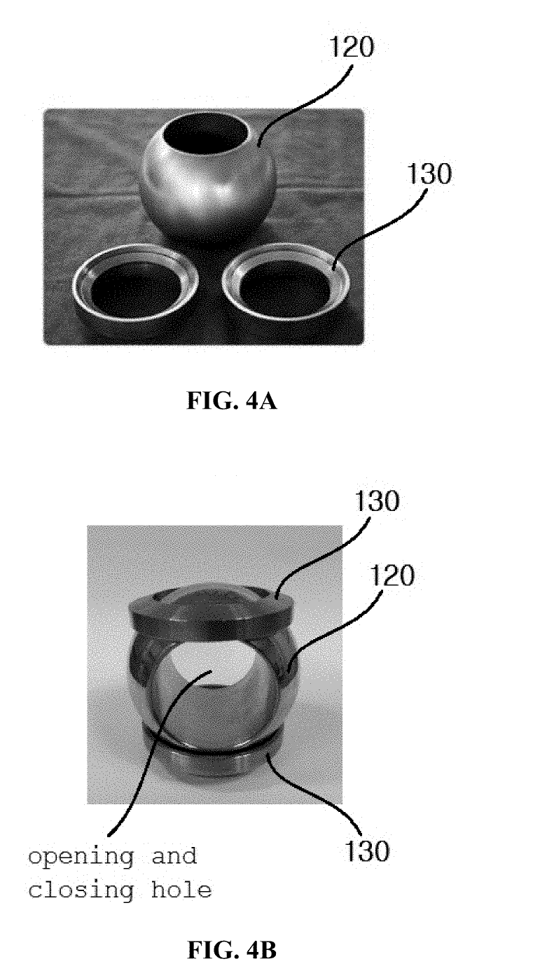

FIG. 1 is a schematic view illustrating the overall construction of a metal seat ball valve apparatus 100 provided with a micro-alloying layer, according to one embodiment of the present invention. FIG. 2 is a picture illustrating an actual metal seat ball valve apparatus 100 shown in FIG. 1. FIG. 3 is a schematic view illustrating a metal ball valve 120 and a metal seat of FIG. 1. FIG. 4 is a picture of an actual metal ball valve 120 and a metal seat 130 shown in FIG. 2.

Referring to FIGS. 1 to 4, the metal seat ball valve apparatus 100 provided with a micro-alloying layer, according to one embodiment of the present invention, is roughly composed of a valve body 110, a metal ball valve 120, a metal seat 130, and a stem 140.

The valve body 110 is provided with a channel for a powder flow or a fluid flow. The valve body 110 has an installation chamber for receiving the metal ball valve 120 and the metal seat 130 therein.

The valve body 110 functions as a housing and has an input port and an output port at respective ends of the channel. A center portion of the valve body 110 is provided with the installation chamber for receiving the metal ball valve 120 that is mounted to be rotatable in the installation chamber. An upper portion of the valve body 110 is provided with a through hole with which the stem 140 is engaged.

The valve body 110 may be an existing valve body for a conventional ball valve apparatus. Therefore, a detailed description about the valve body 110 will be omitted.

The center portion of the metal ball valve 120 is further provided with an opening and closing hole that is formed to pass through the metal ball valve 120. The metal ball valve 120 selectively opens and closes the channel formed in the valve body 110 by rotating in one direction in conjunction with rotation of the stem 140.

Specifically, referring FIGS. 3 and 4, the metal ball valve 120 has a spherical body and is provided with the opening and closing hole having the same size as the channel formed in the valve body 110.

When the metal ball valve 120 is rotated in one direction, its side surface blocks (closes) or opens the channel formed in the valve body 110. In this case, there may be a clearance between the metal ball valve 120 and the valve body 110. To eliminate this clearance, the metal seats 130 are provided to surround the metal ball valve 120 in a tight contact manner.

The metal seats 130 are respectively disposed at the input port and the output port of the channel formed in the valve body 110 and surrounds the external surface of the metal ball valve 120 in a tight contact manner, thereby allowing no clearance between the metal ball valve 120 and the valve body 110.

Herein, the term ‘clearance’ means a gap between the side surface of the metal ball valve 120 and the input or output port of the channel of the valve body 110 when the side surface of the metal ball valve 120 closes the channel formed in the valve body 110 by rotating in one direction.

The surfaces of the metal ball valve 120 and the metal seats 130 are provided with a chrome alloy layer (hereinafter, also referred to as a micro-alloying layer) containing chrome and K-chrome carbide in a high concentration. After the chrome alloy layer is formed, the metal ball valve 120 and the metal seats 130 undergo thermal treatment. During the thermal treatment, low temperature alloy elements contained in the material of the bodies of the metal ball valve 120 and the metal seats 130 diffuse out to the surfaces thereof, thereby forming a highly rigid and friction-free micro-alloying layer. Therefore, in either the case in which cryogenic power or fluid having a temperature of −197° C. flows through the channel or the case in which hot power or fluid having a temperature of 750° C. or higher flows through the channel, since the metal ball valve 120 and the metal seats 130 have an equal thermal expansion coefficient, the metal ball valve 120 and the metal seat 130 do not form a gap between the valve body and maintain constant sealability and rigidity.

Especially, since the metal ball valve 120 and the metal seats 130 are made of a material having the material structure similar to that of the valve body 110, the metal ball valve 120 and the metal seats 130 exhibit a thermal expansion coefficient similar to that of the valve body 110 even at low temperatures.

During the thermal treatment metal coating of the metal ball valve 120 and the metal seats 130, low temperature alloy elements contained in the material of the metal ball valve 120 and the metal seats 130 diffuse out to the surfaces thereof, thereby forming the highly rigid and friction-free micro-alloying layer.

In addition, the surfaces of the metal ball valve 120 and the metal seat 130 that are coated with a metal may be subject to surface modification, which lowers the friction coefficient between the metal ball valve 120 and the metal seat 130 to 0.5 or below. This surface modification process enables the metal ball valve 120 to have a sphericity of 0.002 mm or lower. Therefore, the metal ball valve 120 and the metal seats 130 can easily slide on each other, which reduces abrasion of the metal ball valve 120 and the metal seats 130. Therefore, the metal ball valve 120 can perform a friction-free smooth rotation.

In addition, since the metal ball valve 120 and the metal seats 130 have high corrosion resistance with respect to chemicals such as hydrochloric acid, sulfuric acid, hydro phosphoric acid, brine, etc., the metal ball valve 120 and the metal seats 130 can be applied to a chemical pipe for transporting highly corrosive chemicals. Since the surfaces of the metal ball valve 120 and the metal seats 130 are finished through a metal coating process with a chrome carbide alloy, the surfaces become to have a surface rigidity of 1700 HV (Vickers hardness number). Therefore, the metal ball valve 120 and the metal seats 130 can be used in high temperature and pressure environments.

In addition, the inside surface of the valve body 110 may undergo the metal coating process such that a chrome carbide alloy layer can be formed on the inside surface of the valve body 110, like the metal ball valve 120 and the metal seat 130. In this case, likewise, the inside surface of the valve body has corrosion resistance and abrasion resistance. In this case, the overall lifespan of the metal seat ball valve apparatus is further prolonged.

The stem 140 is a driving means to rotate the metal ball valve 120. A handle is combined with the stem 140 for ease of manipulation of the valve apparatus.

When an operator holds and rotates the handle, an engagement protrusion provided at an end of the stem 140 and fitted in an engagement recess formed at an upper portion of the metal ball valve 120 is rotated, which causes rotation of the metal ball valve 120 in one direction, thereby opening or closing the channel of the valve body 110.

As the stem 140, an existing rotating means provided for a conventional ball valve apparatus can be used. Therefore, a detailed description about the stem 140 will be omitted.

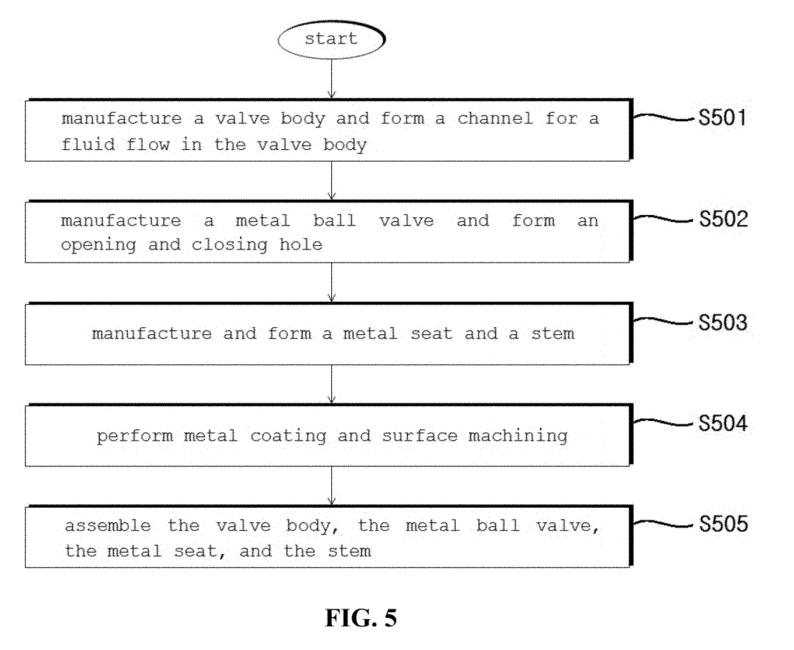

Next, a method of manufacturing the metal seat ball valve apparatus 100 provided with the micro-alloying layer will be sequentially described with reference to FIG. 5.

FIG. 5 is a flowchart describing the method of manufacturing the metal seat ball valve apparatus 100 according to one embodiment of the present invention, which is shown in FIG. 1.

Referring to FIG. 5, a channel for a power flow or a fluid flow is formed in a valve body 110 at Step S501. A metal ball valve 120 that selectively opens and closes the channel by rotating in one direction is then manufactured at Step S502, in which the metal ball valve 120 is formed to have an opening and closing hole that is a through hole passing through the metal ball valve 120. Next, metal seats 130 to be disposed at an input port of the channel and arranged and to surround the external surface of the metal ball valve 120 in a tight contact manner, and a stem 140 used to rotate the metal ball valve 120 in one direction are manufactured at Step S503.

Next, the inside surface of the valve body 110 and the external surfaces of the metal ball valve 120 and the metal seat 130 are coated with a chrome carbide alloy through a metal coating process, and are then subjected to surface machining to have a friction coefficient of 0.5 or less at Step S504.

Next, the metal ball valve 120 and the metal seats 130 are mounted in and assembled with the valve body 110, and the stem 140 is engaged with an upper portion of the metal ball valve 120 at Step S505.

Step S501 to Step S505 are exemplary processes and the sequence of manufacturing the components can be changed. The sequence of metal coating of the components, the sequence of surface machining of the components, and the sequence of assembling the components also can be changed.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A metal seat ball valve apparatus provided with a micro-alloying layer, the apparatus comprising:
a valve body having a channel for a power flow or a fluid flow;
a metal ball valve having an opening and closing hole passing through the metal ball valve, the metal ball valve selectively opening and closing the channel by rotating in one direction;
metal seats respectively disposed at an input port and an output port of the channel and arranged to surround an external surface of the metal ball valve in a tight contact manner; and
a stem rotating the metal ball valve in the direction,
wherein the metal ball valve and the metal seats undergo a metal coating process and a surface machining process when the metal ball valve and the metal seats are manufactured.

2. The metal seat ball valve apparatus according to claim 1, wherein the metal ball valve and the metal seats are made of a material having a material structure similar to that of the valve body, and
surfaces of the metal ball valve and the metal seats are provided, through the metal coating process, with a micro-alloying layer corresponding to a chrome alloy layer formed of an alloy of chrome and a metal.

3. The metal seat ball valve apparatus according to claim 1, wherein a coefficient of friction between the metal ball valve and the metal seats is 0.5 or less.

4. The metal seat ball valve apparatus according to claim 1, wherein the metal ball valve undergoes the surface machining process, thereby having a sphericity of 0.002 mm or less.

5. The metal seat ball valve apparatus according to claim 1, wherein the metal ball valve and the metal seats maintain a predetermined rigidity at a temperature range of from −197° C. to 750° C.

6. The metal seat ball valve apparatus according to claim 1, wherein the metal ball valve and the metal seats have corrosion resistance.

7. The metal seat ball valve apparatus according to claim 1, wherein the metal ball valve and the metal seats have surface rigidity as hard as a Vickers hardness number of 1700 HV.

8. A method for manufacturing a metal seat ball valve provided with a micro-alloying layer, the method comprising:
forming a channel for a power flow or a fluid flow in a valve body;
manufacturing a metal ball valve selectively opening and closing the channel by rotating in one direction, the metal ball valve having an opening and closing hole formed to pass through the metal ball valve;
manufacturing metal seats to be respectively arranged at an input port and an output portion of the channel and to surround an external surface of the metal ball valve in a tight contact manner;
manufacturing a stem rotating the metal ball valve in the direction;
performing a metal coating process and a surface machining process on surfaces of the metal ball valve and the metal seats; and
assembling the valve body, the metal ball valve, the metal seats, and the stem to produce the metal seat ball valve apparatus.

9. The method according to claim 8, wherein the performing of the metal coating process and the surface machining process comprises coating the surfaces of the metal ball valve and the metal seats a material having an equal thermal expansion coefficient through a K-chrome carbide coating process.

10. The method according to claim 8, wherein a coefficient of friction between the metal ball valve and the metal seats is 0.5 or less.

11. The method according to claim 8, wherein the metal ball valve has a sphericity of 0.002 mm or less after undergoing the surface machining process.

12. The method according to claim 8, wherein the metal ball valve and the metal seats maintain a predetermined rigidity at a temperature range of from −197° to 750°.

13. The method according to claim 8, wherein the metal ball valve and the metal seats have corrosion resistance.

14. The method according to claim 8, wherein the metal ball valve and the metal seats have surface rigidity as hard as a Vickers hardness number of 1700 HV.
